(19) United States
(12) Patent Application Publication
(10) Pub. No.: US 2024/0217818 A1
(43) Pub. Date: Jul. 4, 2024

(54) METHOD AND EQUIPMENT FOR PRODUCING HYDROGEN-ENRICHED GAS

(71) Applicants: INPEX CORPORATION, Minato-ku, Tokyo (JP); JAPAN TECHNOLOGICAL RESEARCH ASSOCIATION OF ARTIFICIAL PHOTOSYNTHETIC CHEMICAL PROCESS, Bunkyo-ku, Tokyo (JP); The University of Tokyo, Bunkyo-ku, Tokyo (JP)

(72) Inventors: Kazunari DOMEN, Bunkyo-ku, Tokyo (JP); Taro YAMADA, Bunkyo-ku, Tokyo (JP); Hiroshi NISHIYAMA, Bunkyo-ku, Tokyo (JP); Yasufumi INAI, Minato-ku, Tokyo (JP); Hiroki AKATSUKA, Minato-ku, Tokyo (JP)

(21) Appl. No.: 18/288,237

(22) PCT Filed: Mar. 29, 2022
(86) PCT No.: PCT/JP2022/015692

§ 371 Date: Oct. 25, 2023

(30) Foreign Application Priority Data
Apr. 27, 2021 (JP) 2021-075319

(51) Int. Cl. C01B 3/50; B01J 23/652; B01J 35/39

(52) U.S. Cl. CPC C01B 3/501; B01J 23/6522; B01J 35/39; C01B 2203/0405; C01B 2203/1064; C01B 2210/001; C01B 2210/0045

(57) ABSTRACT

A method for producing a hydrogen-enriched gas, the method including: (A) generating a mixed gas containing hydrogen and oxygen in a reactor that decomposes water into hydrogen and oxygen using sunlight in the presence of a photocatalyst; (B) collecting the mixed gas in a storage tank; (C) supplying the mixed gas in the storage tank to a gas separation device that includes a membrane having an ability to separate hydrogen and oxygen; and (D) separating a hydrogen-enriched gas from the mixed gas in the gas separation device.

### CROSS REFERENCE TO RELATED APPLICATIONS

This is the U.S. national stage of application No. PCT/JP2022/015692, filed on Mar. 29, 2022. Priority under 35 U.S.C. § 119(a) and 35 U.S.C. § 365(b) is claimed from Japanese Application No. 2021-075319, filed Apr. 27, 2021, the disclosure of which is also incorporated herein by reference.

### TECHNICAL FIELD

The present disclosure relates to a method and an apparatus for producing a hydrogen-enriched gas.

### BACKGROUND ART

A technology for producing a hydrogen gas from water using sunlight in the presence of a photocatalyst is being developed. For example, Patent Literature 1 discloses a method for producing a photocatalyst having hydrogen generation activity in a water decomposition reaction in a visible light range.

### CITATION LIST

### Patent Literature

[Patent Literature 1] Japanese Unexamined Patent Publication No. 2019-037918

### SUMMARY OF INVENTION

### Technical Problem

A mixed gas containing hydrogen and oxygen is generated in a reactor that decomposes water using sunlight energy. The following problems occur in separating a high-concentration hydrogen gas (hereinafter sometimes referred to as a “hydrogen-enriched gas”) from this mixed gas. That is, since the water decomposition reaction in such a reactor largely depends on the intensity of sunlight, the mixed gas to be treated is not generated stably.

The present disclosure has been made to solve the above problems and provides a method for stably producing a hydrogen-enriched gas from a mixed gas even if the amount of the mixed gas containing hydrogen and oxygen generated in the reactor is not stable. Further, the present disclosure provides an apparatus for producing a hydrogen-enriched gas applicable to this method.

### Solution to Problem

A method for producing a hydrogen-enriched gas according to the present disclosure includes the following steps.
(A) A step of generating a mixed gas containing hydrogen and oxygen in a reactor that decomposes water into hydrogen and oxygen using sunlight in the presence of a photocatalyst.
(B) A step of collecting the mixed gas in a first storage tank.
(C) A step of supplying the mixed gas in the first storage tank to a gas separation device that includes a membrane having an ability to separate hydrogen and oxygen.
(D) A step of separating a hydrogen-enriched gas from the mixed gas in the gas separation device.

According to the above producing method, after the (B) step is continued until a certain amount of the mixed gas is accumulated in the first storage tank, the (C) step is started, and thus the mixed gas can be stably supplied to the gas separation device. As a result, the membrane of the gas separation device can sufficiently exhibit its separation ability and can stably separate the hydrogen-enriched gas from the mixed gas.

The producing method may further include the following steps.

A step of collecting the mixed gas in a second storage tank while performing the (C) step.

A step of supplying the mixed gas in the second storage tank to the gas separation device while performing the (B) step.

By performing the (B) step and the (C) step in parallel using a plurality of storage tanks, it is possible to lengthen the operating time of the gas separation device, and it becomes possible to more stably produce the hydrogen-enriched gas.

An apparatus for producing a hydrogen-enriched gas according to the present disclosure includes: a reactor configured to generate a mixed gas containing hydrogen and oxygen through a water decomposition reaction using sunlight in the presence of a photocatalyst: a first storage tank configured to collect the mixed gas: and a gas separation device which includes a membrane having an ability to separate hydrogen and oxygen and to which the mixed gas from the first storage tank is supplied.

According to the above producing apparatus, after a certain amount of the mixed gas is stored in the first storage tank, the mixed gas in the first storage tank is supplied to the gas separation device, and thus the membrane of the gas separation device can sufficiently exhibit its separation ability and can stably separate the hydrogen-enriched gas from the mixed gas.

The above producing apparatus may further include: a second storage tank configured to collect the mixed gas: and a valve mechanism configured to be able to switch from a state in which the first storage tank communicates with the gas separation device to a state in which the second storage tank communicates with the gas separation device. Since the producing apparatus includes a plurality of storage tanks and a communication state between these storage tanks and the gas separation device can be switched, it is possible to lengthen the operating time of the gas separation device, and it becomes possible to more stably obtain the hydrogen-enriched gas.

Each of the first and second storage tanks may have a ceiling portion provided with an opening through which the mixed gas enters and exits, and a partition plate extending downward from a lower surface of the ceiling portion and forming a flow path for the mixed gas together with the lower surface of the ceiling portion. By providing such a flow path, even if the mixed gas explodes in the storage tank, the effect can be sufficiently reduced. The producing apparatus according to the present disclosure is not limited to having a reactor that uses sunlight energy to generate a mixed gas and may have other types of reactors. That is, an apparatus for producing a hydrogen-enriched gas according to another aspect of the present disclosure includes: a reactor configured to generate a mixed gas containing hydrogen and oxygen: a first storage tank configured to collect the mixed gas; and a gas separation device which includes a membrane having an ability to separate hydrogen and oxygen and to which the mixed gas from the first storage tank is supplied.

### Advantageous Effects of Invention

According to the present disclosure, there is provided a method for stably producing a hydrogen-enriched gas from a mixed gas even if the amount of the mixed gas containing hydrogen and oxygen generated in the reactor is not stable. Further, according to the present disclosure, there is provided an apparatus for producing a hydrogen-enriched gas applicable to this method.

### BRIEF DESCRIPTION OF DRAWINGS

FIG. 1 is a flow view schematically showing an embodiment of an apparatus for producing a hydrogen-enriched gas according to the present disclosure.

FIG. 2 is a perspective view schematically showing a main configuration of a reactor shown in FIG. 1.

FIG. 3 is a cross-sectional view schematically showing an example of a configuration of a reactor unit.

FIG. 4 is a schematic view showing an example of a communication state of a pipe in a storage unit.

FIG. 5 is a schematic view showing another example of the communication state of the pipe in the storage unit.

FIG. 6 is a schematic view showing another example of the communication state of the pipe in the storage unit.

FIG. 7 is a schematic view showing another example of the communication state of the pipe in the storage unit.

FIG. 8A is a perspective view schematically showing an example of a storage tank, and FIG. 8B is a cross-sectional view along line b-b in FIG. 8A.

FIG. 9 is a graph showing an example of test results using two storage tanks together.

FIG. 10 is a photograph showing an apparatus for producing a hydrogen-enriched gas according to an example.

FIG. 11 is a graph showing the cumulative amounts of a mixed gas, a filtered gas (a hydrogen-enriched gas), and an off-gas (an oxygen-enriched gas) generated when the producing apparatus shown in FIG. 10 is operated for about 10 hours.

FIG. 12A is a graph showing sunlight intensity and ultraviolet intensity when the producing apparatus shown in FIG. 10 is operated for about 10 hours, and FIG. 12B is a graph showing a mixed gas generation rate at that time.

### DESCRIPTION OF EMBODIMENTS

Hereinafter, an embodiment of the present disclosure will be described in detail with reference to the drawings. In the following description, the same or corresponding parts are denoted by the same reference signs, and overlapping descriptions are omitted. In addition, unless otherwise specified, positional relationships such as up, down, left, and right are based on the positional relationships shown in the drawings. The dimensional ratios of the drawings are not limited to the illustrated ratios.

### <Apparatus for Producing Hydrogen-Enriched Gas>

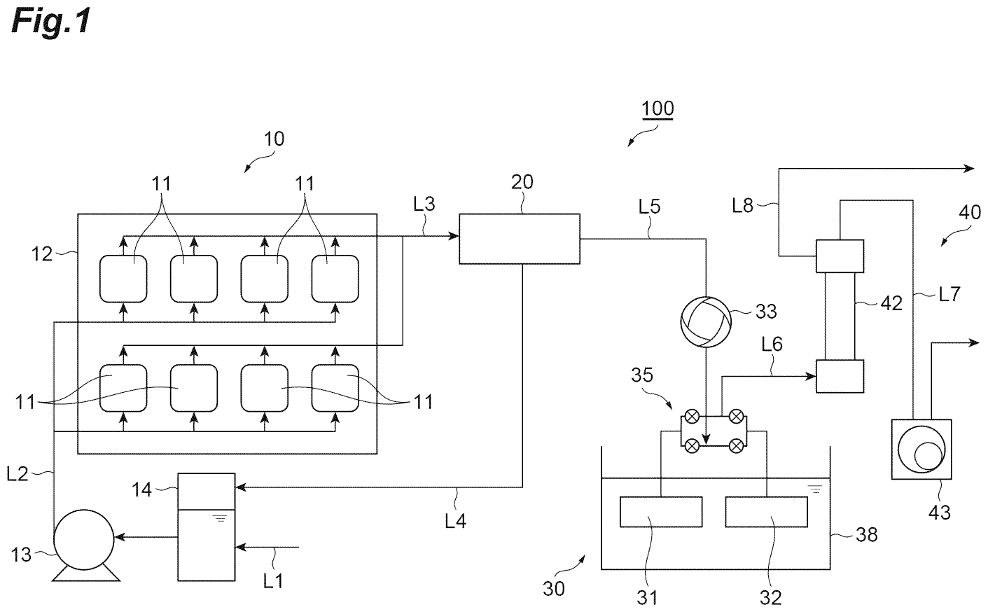

FIG. 1 is a flow view schematically showing a producing apparatus according to the present embodiment. The producing apparatus 100 shown in this figure is for generating a mixed gas containing hydrogen and oxygen from water using sunlight energy and then separating and recovering a hydrogen-enriched gas from this mixed gas. The producing apparatus 100 includes a reactor 10, a separator 20, a storage unit 30, and a gas separation device 40, and these components are connected to each other by a pipe (hereinafter sometimes referred to as a “line”). Pumps and gauges are installed on the line as needed.

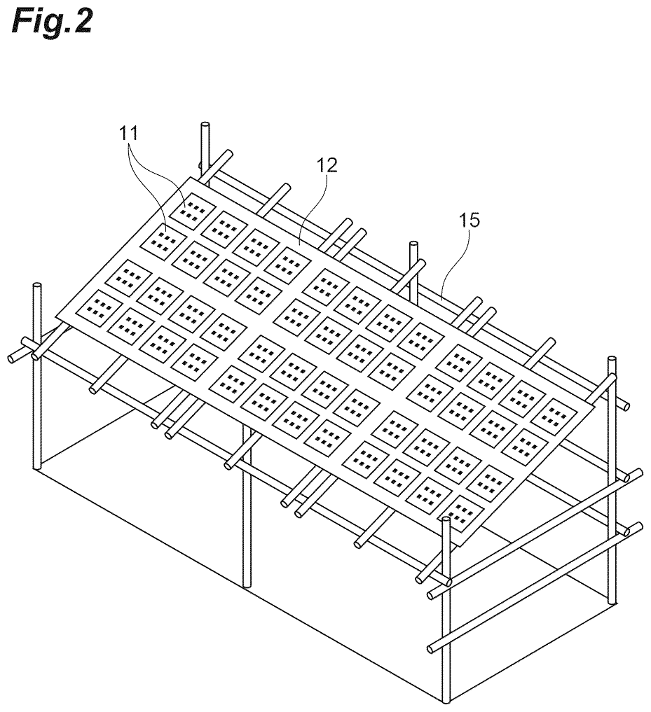

The reactor 10 generates a mixed gas containing hydrogen and oxygen through a water decomposition reaction using sunlight in the presence of a photocatalyst. As shown in FIG. 1, the reactor 10 includes a plurality of reactor units 11, a plate 12 supporting them, a pump 13 for supplying water to each reactor unit 11, and a water storage tank 14. Water is supplied to the water storage tank 14 through a line L1, and water separated by the separator 20 is returned through a line L4. The pump 13 is installed in the middle of a line L2 through which water is transferred from the water storage tank 14 to the reactor 10. Although eight reactor units 11 are schematically shown in FIG. 1, the number is not limited to eight. FIG. 2 schematically shows 48 reactor units 11.

FIG. 2 is a perspective view schematically showing a main configuration of the reactor 10. As shown in this figure, the plate 12 supporting the plurality of reactor units 11 is fixed to a frame 15 in an inclined state. A mechanism for automatically changing the inclination angle or orientation of the plate 12 according to the movement of the sun during the day may be employed. The reactor unit 11 is, for example, a panel with a thickness of about 25 to 40 mm. In a plan view, the area of the reactor unit 11 is, for example, about 500 to 1000 cm², and about 50% to 80% of this area preferably contributes to the water decomposition reaction using sunlight.

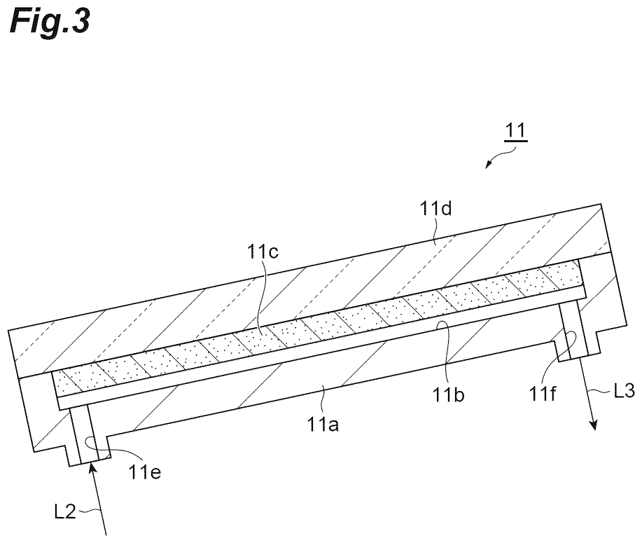

FIG. 3 is a cross-sectional view schematically showing an example of a configuration of the reactor unit 11. As shown in this figure, the reactor unit 11 includes a case 11a, a photocatalyst sheet 11c disposed in a recess 11b of the case 11a, and a glass plate 11d disposed to cover the photocatalyst sheet 11c. In a state where the reactor unit 11 is installed on the inclined plate 12, a water supply port 11e is formed on the lower peripheral edge portion of the case 11a, and a gas exhaust port 11f is formed on the higher peripheral edge portion of the case 11a. A gap of about 0.05 to 5.0 mm, for example, is provided between the case 11a and the photocatalyst sheet 11c. When the gap is 0.05 mm or more, water and generated gas tend to move easily in the reactor unit 11. On the other hand, when the gap is 5.0 mm or less, a dead space tends to be reduced.

The photocatalyst sheet 11c contains a photocatalyst that promotes a photochemical reaction in which water is decomposed into hydrogen and oxygen with sunlight energy. The thickness of the photocatalyst sheet 11c is, for example, about 7 to 15 μm. It is preferable to use a catalyst in which a hydrogen generation promoter and an oxygen generation promoter are supported on an oxide photocatalyst so that water can be decomposed with a high quantum yield. A specific example of a photocatalyst having excellent activity is one in which Rh/Cr₂O₃ as a hydrogen generation promoter and CoOOH as an oxygen generation promoter are supported on Al-doped SrTiO₃ by a photoelectrodeposition method. The photoelectrodeposition method is a method in which positive and negative charges generated through photoexcitation reduce or oxidize a metal salt that serves as a precursor on the surface of a photocatalyst particle, depositing a metal or metal oxide, thereby supporting a promoter.

The separator 20 separates a gas-liquid mixed fluid supplied from the reactor 10 through a line L3 into water and gas (see FIG. 1). The water separated by the separator 20 is returned to the water storage tank 14 through the line L4 as described above. The mixed gas separated by the separator 20 is transferred to the storage unit 30 through a line L5.

As shown in FIG. 1, the storage unit 30 includes a storage tank 31 (a first storage tank), a storage unit tank 32 (a second storage tank), and a valve mechanism 35 having four valves. The valve mechanism 35 can switch a flow path by changing the open/closed states of the four valves. That is, the valve mechanism 35 can switch between a state in which the separator 20 communicates with the storage tank 31 and a state in which the separator 20 communicates with the storage tank 32. In addition to this, the valve mechanism 35 can switch between a state in which the storage tank 31 communicates with the gas separation device 40 and a state in which the storage tank 32 communicates with the gas separation device 40.

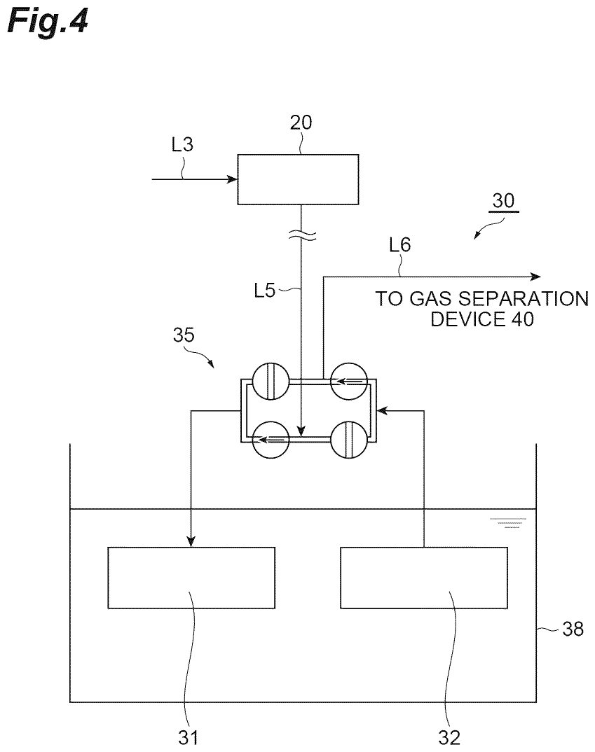

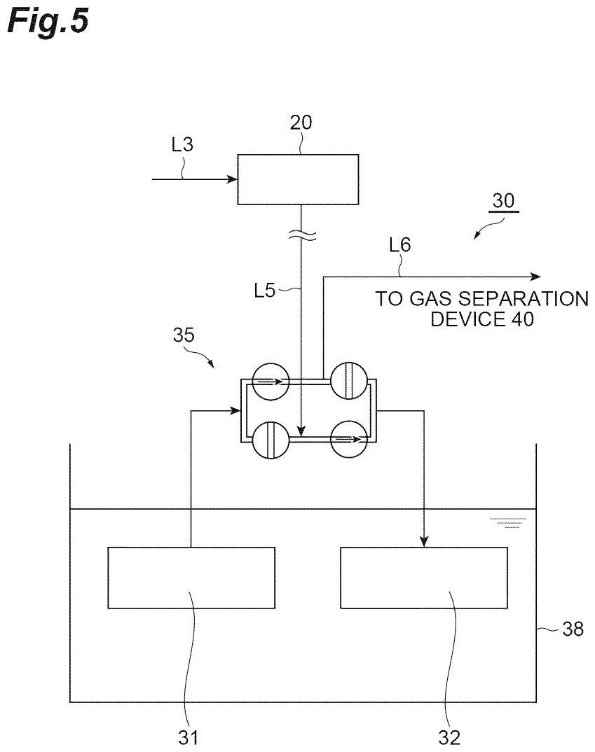

FIG. 4 shows a state in which the storage tank 31 communicates with the separator 20 and the storage tank 32 communicates with the gas separation device 40. In this state, the mixed gas is supplied from the separator 20 to the storage tank 31 and at the same time, the mixed gas is supplied from the storage tank 32 to the gas separation device 40. FIG. 5 shows a state in which the storage tank 32 communicates with the separator 20 and the storage tank 31 communicates with the gas separation device 40. In this state, the mixed gas is supplied from the separator 20 to the storage tank 32 and at the same time, the mixed gas is supplied from the storage tank 31 to the gas separation device 40.

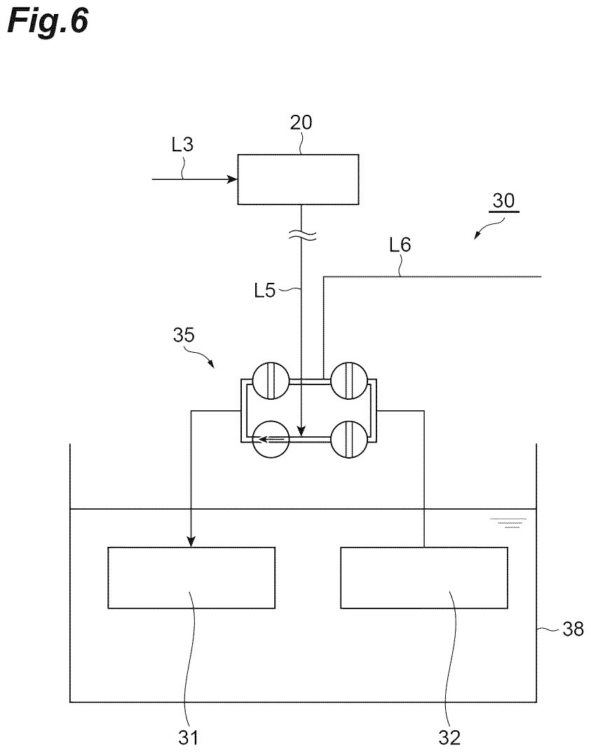

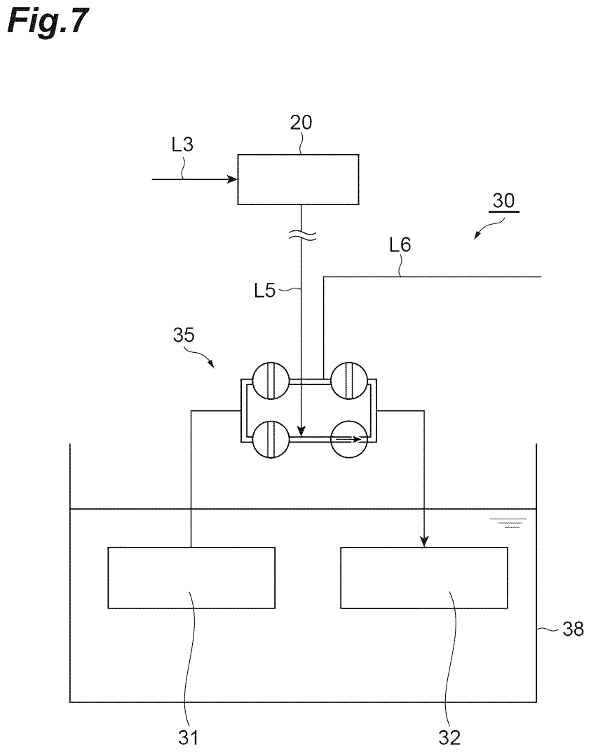

FIG. 6 shows a state in which the storage tank 31 communicates with the separator 20, while the storage tank 32 does not communicate with the gas separation device 40. In this state, the mixed gas is supplied from the separator 20 to the storage tank 31, while the supply of the mixed gas to the gas separation device 40 is stopped. FIG. 7 shows a state in which the storage tank 32 communicates with the separator 20, while the storage tank 31 does not communicate with the gas separation device 40. In this state, the mixed gas is supplied from the separator 20 to the storage tank 32, while the supply of the mixed gas to the gas separation device 40 is stopped.

The storage tanks 31 and 32 each collect the mixed gas by a water replacement method. That is, as shown in FIG. 1, the storage tanks 31 and 32 are disposed in a water tank 38 in which water is accommodated. A booster pump 33 is installed in the middle of the line L5 that transfers the mixed gas to the storage tanks 31 and 32. The mixed gas is injected into the storage tanks 31 and 32 by pressurizing the mixed gas with the booster pump 33. In addition, it is preferable that the storage tanks 31 and 32 be each provided with a water level gauge (not shown). By monitoring the water level in each of the storage tanks 31 and 32 with the water gauge, it is possible to accurately grasp the timing of stopping the booster pump 33 and the timing of operating the valve mechanism 35 to switch the flow path.

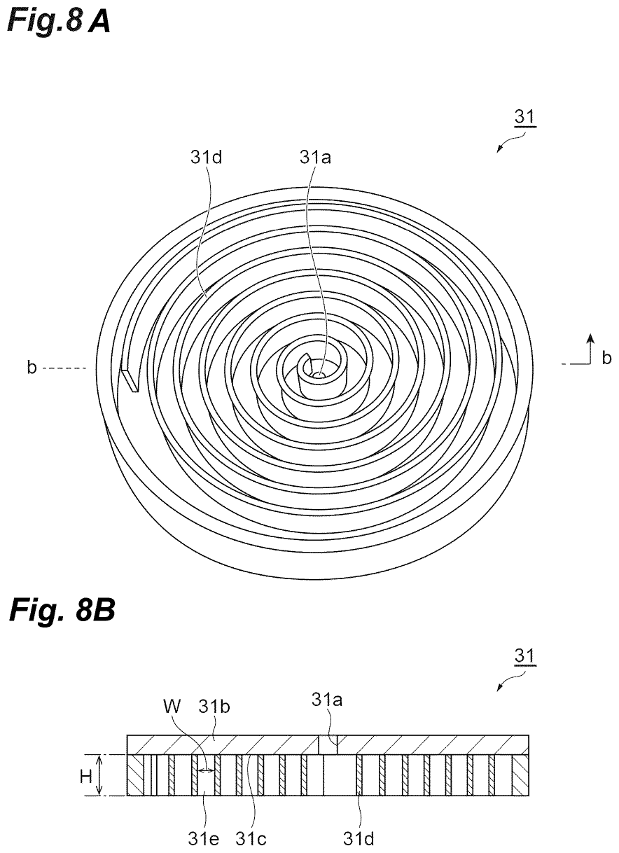

FIG. 8A is a perspective view schematically showing the storage tank 31, and FIG. 8B is a cross-sectional view along line b-b in FIG. 8A. FIG. 8A shows a state in which the storage tank 31 is disposed upside down. As shown in these figures, the storage tank 31 has a ceiling portion 31b provided with an opening 31a through which the mixed gas enters and exits. The mixed gas from the separator 20 is supplied to the storage tank 31 through the opening 31a and the mixed gas in the storage tank 31 is transferred to the gas separation device 40. The storage tank 32 also has the same configuration as that of the storage tank 31.

As shown in FIG. 8A and FIG. 8B, the storage tank 31 has a spiral partition plate 31d extending downward from a lower surface 31c of the ceiling portion 31b. The partition plate 31d forms a flow path 31e for the mixed gas together with the lower surface 31c of the ceiling portion 31b. By storing the mixed gas in the narrow and long flow path 31e, even if the mixed gas explodes in the storage tank 31, the effect can be sufficiently reduced. An interval between the spiral partition plates 31d (a width of the flow path 31e, a width W shown in FIG. 8B) is, for example, 0.5 to 3 cm. The height of the partition plate 31d (the height of the flow path 31e, a height H shown in FIG. 8b) is, for example, 0.5 to 5 cm. The cross-sectional area (the width W×the height H) of the flow path 31e is, for example, 5 cm² or less. The length of the flow path 31e may be set according to the volume of the mixed gas to be stored.

The gas separation device 40 separates the mixed gas supplied from the storage unit 30 through a line L6 into a hydrogen-enriched gas and an oxygen-enriched gas (see FIG. 1). In the present embodiment, a separation membrane cartridge 42 that includes therein a membrane having an ability to separate hydrogen and oxygen is used. An example of the separation membrane cartridge is one that includes a polyimide hollow fiber membrane. An example of a commercially available product is a dehumidifying membrane (UBE membrane dryer) manufactured by Ube Industries, Ltd. This dehumidifying membrane includes a plurality of series (for example, DM series, UM series, and UMS series). From these series, the model to be used may be selected according to the scale of the reactor 10, for example. Besides a method using the separation membrane cartridge, for example, a pressure swing adsorption (PSA) method and a cryogenic separation method are known as gas separation methods. Compared to these methods, the method using the separation membrane cartridge has an advantage in that gas separation can be performed even if the throughput per unit time is small and scale-up can be relatively easily achieved by increasing the number of separation membrane cartridges.

The hydrogen-enriched gas separated in the gas separation device 40 is transferred to a subsequent apparatus through a line L7. A vacuum pump 43 is installed in the middle of the line L7. On the other hand, the oxygen-enriched gas is transferred to a subsequent apparatus through line L8.

### <Method for Producing Hydrogen-Enriched Gas>

A method for producing a hydrogen-enriched gas using the producing apparatus 100 will be described. This method includes the following steps.
(a) A step of generating a mixed gas containing hydrogen and oxygen by irradiating the reactor unit 11 of the reactor 10 with sunlight.
(b) A step of collecting the mixed gas that has undergone treatment in the separator 20 in the storage tank 31 by a water replacement method.
(c) A step of supplying the mixed gas in the storage tank 31 to the gas separation device 40.
(d) A step of separating a hydrogen-enriched gas from the mixed gas in the gas separation device 40.

According to the above producing method, after the (b) step is continued until a certain amount of the mixed gas is accumulated in the storage tank 31, the (c) step is started, and thus the mixed gas can be stably supplied to the gas separation device 40. As a result, the membrane of the gas separation device 40 can sufficiently exhibit its separation ability and can stably separate the hydrogen-enriched gas from the mixed gas. In addition, since the storage tank 31 collects the mixed gas by the water replacement method, the mixed gas in the storage tank 31 is in a water-sealed state and contains water vapor at a partial pressure of the saturated vapor pressure, and thus safety is enhanced.

The producing method may further include the following steps.

A step of collecting the mixed gas in the storage tank 32 by the water replacement method while performing the (c) step (see FIG. 5).

A step of supplying the mixed gas in the second storage tank 32 to the gas separation device 40 while performing the (b) step (see FIG. 4).

By performing the (c) step and the (d) step in parallel using the two storage tanks 31 and 32, it is possible to lengthen the operating time of the gas separation device 40, and it becomes possible to more stably produce the hydrogen-enriched gas.

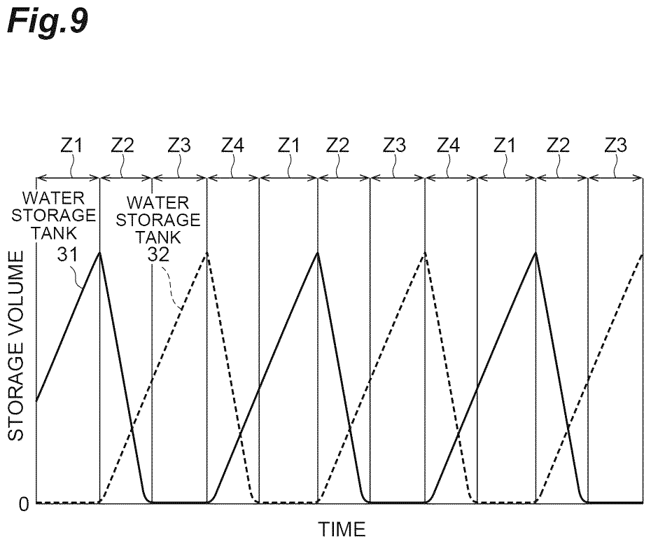

FIG. 9 is a graph showing an example of test results using the two storage tanks 31 and 32 together. The following processes are performed in time zones Z1 to Z4 shown in FIG. 9.
Z1 . . . The mixed gas is supplied from the separator 20 to the storage tank 31 (see FIG. 6).
Z2 . . . The mixed gas is supplied from the storage tank 31 to the gas separation device 40, and the mixed gas is supplied from the separator 20 to the storage tank 32 (see FIG. 5).
Z3 . . . The mixed gas is supplied from the separator 20 to the storage tank 32 (see FIG. 7).
Z4 . . . The mixed gas is supplied from the storage tank 32 to the gas separation device 40, and the mixed gas is supplied from the separator 20 to the storage tank 31 (see FIG. 4).

That is, in the test results shown in FIG. 9, the gas separation device 40 is stopped in the time zones Z1 and Z3 but is operating in the time zones Z2 and Z4. For example, by increasing the amount of the mixed gas generated per unit time by increasing the number of reactor units 11, it is possible to lengthen the time during which the gas separation device 40 is operating. Although the amount of the mixed gas supplied to the gas separation device 40 per unit time depends on the type and size of the separation membrane provided in the gas separation device 40, the amount thereof is, for example, about 5 to 7 L/min in the case of a pilot plant, is, for example, 10 L/min or more in the case of a larger apparatus, and may be 30 L/min or more.

Although the embodiment of the present disclosure has been described above in detail, the present invention is not limited to the above embodiment. For example, in the above embodiment, the case of using two storage tanks 31 and 32 has been illustrated, but one storage tank may be used alone, or three or more storage tanks may be used.

The mixed gas containing hydrogen and oxygen is potentially explosive. From the viewpoint of solving the problem of ensuring a high level of safety in the process of handling this mixed gas, in the above embodiment, the case in which the spiral partition plate forms the flow path in the storage tank has been illustrated. A structure other than the spiral partition plate may be employed as long as the power of the explosion can be reduced by finely partitioning the space in which the mixed gas is stored. For example, the storage tank may be filled with a tubular member (for example, Mitsuba Drain (trade name) manufactured by Nihon Drain Co., Ltd.) or a plate-shaped member. Alternatively, a thin and long tube may be used, and the mixed gas may be stored in this tube. The flow path cross-sectional area of the tube is, for example, 5 cm² or less. When this area is 5 cm² or less, even if the mixed gas stored in the tube is ignited, the power of the explosion can be sufficiently reduced, and according to the studies of the present inventors, it is inferred that if this area is around 1 mm², the flame will not propagate. The length of the tube may be set according to the volume of the mixed gas to be stored and may be longer than 150 m, for example. As long as the process of replacing the water accommodated in the tube with the mixed gas and the process of replacing the mixed gas accommodated in the tube with water again can be performed efficiently, the tube may be, for example, in a wound state around a winding core or in a bundled state.

In the above embodiment, the storage tanks 31 and 32 that collect the mixed gas by the water replacement method have been illustrated, but other types of storage tanks may be employed. For example, from the viewpoint of safety, a variable-capacity low-pressure gas holder, a liquid-sealed quasi-isobaric gas holder, or the like may be employed.

In the above embodiment, the reactor 10 that uses sunlight energy to generate a mixed gas is illustrated, but other types of reactors may be employed. For example, a reactor that uses light from an LED to generate a mixed gas may be used. When light from an LED is used, a mixed gas can be stably generated in the reactor day and night. However, for example, in a case where the amount of the mixed gas generated per unit time in the reactor is less than the optimum flow rate of the separation membrane cartridge, it is useful to perform an operation of storing the mixed gas in the storage tank, and then supplying the mixed gas in the storage tank to the gas separation device.

### EXAMPLE

An example according to the present disclosure will be described below. In addition, the present invention is not limited to the following example.

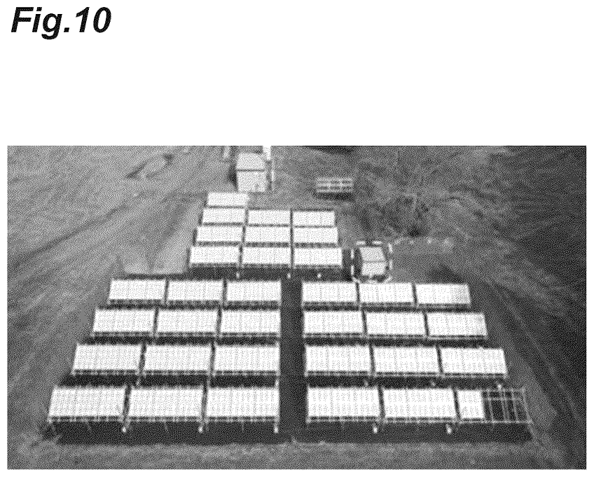

A total of 160 reactor units were made. The structure of the reactor unit is the same as the reactor unit 11 shown in FIG. 3. Using these reactor units, an apparatus for producing a hydrogen-enriched gas having the same configuration as in FIG. 1 was constructed (see FIG. 10). The main configuration of the producing apparatus was as follows.

### <Reactor Unit>

Photocatalyst: One in which Rh/Cr₂O₃ as a hydrogen generation promoter and CoOOH as an oxygen generation promoter are supported on Al-doped SrTiO₃ by a photoelectrodeposition method.
Size of photocatalyst sheet: 25 cm×25 cm (area: 625 cm²)
Total area of photocatalyst sheet: 100 m² (=625 cm²×1600 sheets)
Inclination angle: 30°

### <Storage Unit>

Aspect of storage tank: Water replacement shallow tank
Capacity of storage tank: 3 L
Depth of storage tank: 15 cm
The number of storage tanks: 2
Filling material: Mitsuba Drain (trade name, manufactured by Nihon Drain Co., Ltd.)

### <Gas Separation Device>

Separation membrane cartridge: UMS-B2 (model number, manufactured by Ube Industries, Ltd., optimum flow rate 6 L/min)

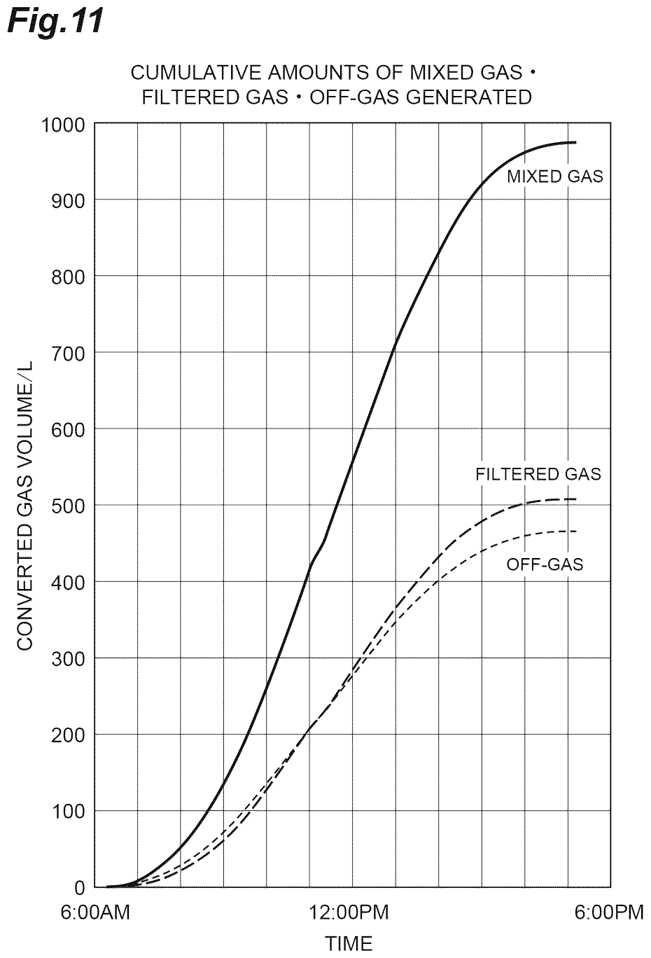

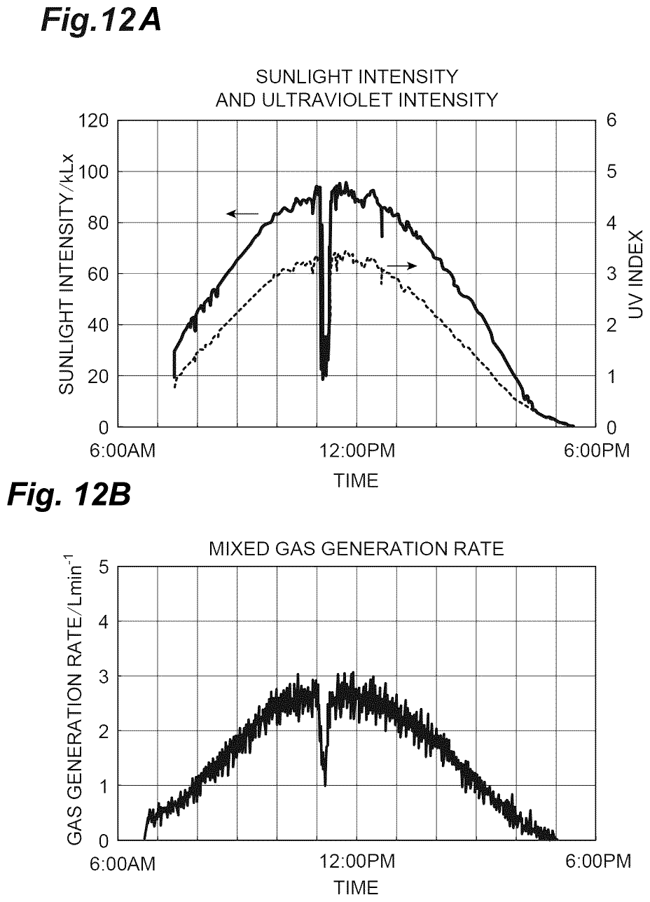

FIG. 11 is a graph showing the cumulative amounts of a mixed gas, a filtered gas (a hydrogen-enriched gas), and an off-gas (an oxygen-enriched gas) generated when the producing apparatus according to the present example is operated for about 10 hours. It was a sunny day in October. FIG. 12A is a graph showing sunlight intensity and ultraviolet intensity at that time, and FIG. 12B is a graph showing a mixed gas generation rate at that time. FIG. 12B shows a mixed gas generation rate in a reactor with a half area (50 m²) of the total area (100 m²) of the photocatalyst sheet. The reactor as a whole was able to produce about 6 L/min of the mixed gas at a peak.

In the time zone when the light intensity of the sun was strong, it was possible to generate the same amount of the mixed gas as the optimum flow rate (6 L/min) of the separation membrane cartridge, and thus the mixed gas was continuously supplied to the separation membrane cartridge. On the other hand, in the time zone when the light intensity of the sun was low, the operation of storing the mixed gas in the storage tank and the operation of supplying the mixed gas from the storage tank to the separation membrane cartridge were repeated. By these operations, a hydrogen-enriched gas and an oxygen-enriched gas could be stably produced from the mixed gas. The hydrogen concentration of the hydrogen-enriched gas stably exceeded 93%.

### REFERENCE SIGNS LIST

10: Reactor, 11: Reactor unit, 11a: Case, 11b: Recess, 11c: Photocatalyst sheet, 11d: Glass plate, 11e: Water supply port, 11f: Gas exhaust port, 12: Plate, 13: Pump, 14: Water storage tank, 15: Frame, 20: Separator, 30: Storage unit, 31: Storage tank, 31a: Opening, 31b: Ceiling portion, 31c: Lower surface, 31d: Partition plate, 31e: Flow path, 32: Storage tank, 33: Booster pump, 35: Valve mechanism, 38: Water tank, 40: Gas separation device, 42: Separation membrane cartridge, 43: Vacuum pump, 100: Producing apparatus, L1 to L8: Line

1. A method for producing a hydrogen-enriched gas, the method comprising steps of:
(A) generating a mixed gas containing hydrogen and oxygen in a reactor that decomposes water into hydrogen and oxygen using sunlight in a presence of a photocatalyst;
(B) collecting the mixed gas in a first storage tank;
(C) supplying the mixed gas in the first storage tank to a gas separation device that includes a membrane having an ability to separate hydrogen and oxygen; and
(D) separating a hydrogen-enriched gas from the mixed gas in the gas separation device.

2. The method for producing a hydrogen-enriched gas according to claim 1, the method further comprising steps of:
collecting the mixed gas in a second storage tank while performing the step (C); and
supplying the mixed gas in the second storage tank to the gas separation device while performing the step (B).

3. An apparatus for producing a hydrogen-enriched gas, the apparatus comprising:
a reactor configured to generate a mixed gas containing hydrogen and oxygen through a water decomposition reaction using sunlight in a presence of a photocatalyst;
a first storage tank configured to collect the mixed gas; and
a gas separation device which includes a membrane having an ability to separate hydrogen and oxygen and to which the mixed gas from the first storage tank is supplied.

4. The apparatus for producing a hydrogen-enriched gas according to claim 3, the apparatus further comprising:
a second storage tank configured to collect the mixed gas; and
a valve mechanism configured to be able to switch from a state in which the first storage tank communicates with the gas separation device to a state in which the second storage tank communicates with the gas separation device.

5. The apparatus for producing a hydrogen-enriched gas according to claim 4, both of the first and second storage tanks comprising:
a ceiling portion provided with an opening through which the mixed gas enters and exits, and
a partition plate extending downward from a lower surface of the ceiling portion and forming a flow path for the mixed gas together with the lower surface of the ceiling portion.

6. An apparatus for producing a hydrogen-enriched gas, the apparatus comprising:
a reactor configured to generate a mixed gas containing hydrogen and oxygen;
a first storage tank configured to collect the mixed gas; and
a gas separation device which includes a membrane having an ability to separate hydrogen and oxygen and to which the mixed gas from the first storage tank is supplied.
